(19) United States
(12) Patent Application Publication
(10) Pub. No.: US 2018/0160802 A1
(43) Pub. Date: Jun. 14, 2018

(54) Stackable Shoe Rack Unit and Corresponding Shoe Rack

(71) Applicant: ChengLong Wang, Beijing (CN)

(72) Inventor: ChengLong Wang, Beijing (CN)

(73) Assignee: Shanghai Solenest Trading Company, Shanghai (CN)

(21) Appl. No.: 15/619,546

(22) Filed: Jun. 12, 2017

(30) Foreign Application Priority Data
Dec. 12, 2016 (CN) 201621354871.4

(51) Int. Cl. A47B 61/04; A47B 47/00; A47B 87/02; F16B 1/00

(52) U.S. Cl. CPC A47B 61/04; A47B 47/0091; F16B 2001/0035; F16B 1/00; A47B 87/0269

(57) ABSTRACT

The present invention discloses stackable shoe rack unit and shoe rack made therefrom, comprises: a pallet for placing shoes, both ends of the pallet extend upwardly to form a first plate and a second plate respectively; the first plate and a second plate extending toward each other at their respective extension ends to form a first support plate and a second support plate respectively; first magnetic member is provided on both upper surfaces of the first support plate and second support plate; and second magnetic member matching the first magnetic member is provided on a lower surface of the pallet. The stackable shoe rack unit may be used to form single-column-multiple-level shoe rack, or may be used to form multi-column-multi-level shoe rack, there are variety of possible ways for combination; the resulting shoe rack takes up little space, is suitable for both shopping malls and home environments, has wide range of applications, and is both practical and easy to use.

### CROSS REFERENCE TO OTHER APPLICATIONS

This application claims the priority of Chinese Patent Application No. 201621354871.4 filed on Dec. 12, 2016, wherein the entirety of the Chinese priority application is incorporated herein by reference for all purposes.

### TECHNICAL FIELD

The present invention relates to a technical field of everyday life tool, particularly to stackable shoe rack unit and shoe rack made therefrom

### BACKGROUND OF THE INVENTION

Shoes are daily necessities, useful for warding off cold, preventing stabbing and cuts, and providing general foot protection. In ancient times, when manufacture capability is limited, people use bark and animal skins wrapped around feet to serve as shoes, with the advancement of civilization and manufacture capability, people gradually can put on shoes, materials for making shoes have been improved, shoe styles, color, etc. all have been greatly diversified, people now wear different styles of shoes according to their clothing and social occasions. Consequently, today where there is great material wealth, everyone owns many pairs of shoes, leather shoes, sports shoes, cloth shoes, slippers, etc. are must have. Having many pairs of shoes also brought challenges, there is simply not enough space to store the shoes.

Whether in shopping malls or individual homes, we need more space to store shoes. Furthermore, shoes are currently placed mainly in a side-by-side fashion, taking up a large spatial footprint. The current way of storing shoes is also dull, not visually pleasing. Some shoes are placed with two shoes in a pair stacked on top of each other, although this reduces the amount of space occupied, it causes shoes to deform easily, affecting the aesthetics and comfort of the shoes. Some shoes are placed directly in boxes, the boxes are then stacked on top of each other, although this saves space, the stacked shoe boxes are not very stable, the shoes placed inside do not have good air ventilation, causing mildew to form and shoes to rot, wasting valuable resources, and increasing the cost of living.

Therefore, how to make a shoe rack that takes up a small spatial footprint and provides for good shoe ventilation is still a challenge for one skilled in the art.

### SUMMARY OF THE INVENTION

The object of the invention is to provide a stackable shoe rack unit and shoe rack made therefrom, the stackable shoe rack unit can be used to form single-column-multiple-level shoe racks, it can also be used to form multiple-column-multiple-level shoe racks, with many possible ways for combination; it is suitable for both shopping malls and home environment, has a wide range of applications, takes up small spatial footprint, and is very practical and easy to use.

The present invention provides the following technical solution:

a stackable shoe rack unit, comprising:

a pallet for placing shoes, two ends of the pallet extends upwardly to form a first plate and a second plate; the extension ends of the first plate and the second plate extend towards each other to form a first support plate and a second support plate respectively;

a first magnetic member is provided on each of the upper surfaces of the first support plate and the second support plate;

a second magnetic member corresponding to or matching the first magnetic member is provided on the lower surface of the pallet.

In this aspect, the individual shoe rack units are interconnected through magnetic members. This not only allows tight interconnections between the individual shoe rack units, it also makes the shoe rack formed structurally stable, do not collapse or deform easily. The shoe rack unit can be used to form single-column-multiple-level shoe rack or multiple-column-multiple-level shoe rack. There is a wide range of ways for combining the individual shoe rack units that takes up little space. This type of stackable shoe rack is suitable for both shopping malls and home environment, has a wide range of potential applications, takes up minimum amount of space, is very practical and easy to use.

In this aspect, the stackable shoe rack unit can be designed for a single pair of shoes or multiple pairs of shoes placed side-by-side, the size and style of the shoe rack unit can be selected based on the available space for a shoe rack, without having to consider making available enough space for the shoe rack, thus saves space and improves interior space utilization; in addition, identical or different shoe rack units can be assembled together or placed in separate spaces according to user needs and local conditions; the shoe rack formed from the stackable shoe rack units can have diverse styles and is highly individualized.

Furthermore, preferably the upper surface of the pallet is provided with anti-slip belt.

In this aspect, by providing the anti-slip belt slip on the pallet, one can effectively prevent shoes from sliding on the pallet, which can cause the shoes placed on the shoe rack unit to fall or cause the shoe rack formed from the shoe rack unit to become unstable. The anti-slip belt ensures the stability of the shoes placed on the shoe rack and ensures the stability of the shoe rack unit.

Furthermore, preferably the vertical height of the first plate is greater than the vertical height of the second plate, the first plate is provided with a through hole; and/or; the first support plate and the second support plate are located on the same inclined surface.

In this aspect, the through hole provided on the shoe rack unit makes it more convenient for a user to move and assemble the shoe rack unit, reduces the weight of the shoe rack unit itself, makes it possible to select a pair of shoes by viewing through the through hole, and makes the design of the shoe rack unit scientific and ergonomic.

In this aspect, placing the first support plate and second support plate on the same inclined surface ensures close contact between the shoe rack units, thus ensuring the stability and firm connection between the first magnetic member and the second magnetic member, ensuring the stability and robustness of the shoe rack formed from the shoe rack units.

Furthermore, preferably the pallet, the first plate, the first support plate and the second support plate form a triangle.

In this aspect, the triangle is the most stable structure, triangular shoe rack unit ensures its own stability, and ensures the stability of the shoe rack formed from the triangular shoe rack units.

Furthermore, preferably the triangle is an isosceles triangle; the first plate forms the base of said isosceles triangle; and/or; the apex angle of the isosceles triangle is 40°.

In this aspect, when the apex angle of the isosceles triangle is 40°, the apex angle is similar to the angle formed by the tip of a sneaker, this allows for maximum spatial utilization when sneakers are stored on the shoe rack unit.

Furthermore, preferably an opening is provided between the extension ends of the first support plate and the second support plate.

In this aspect, the opening provided for the shoe rack unit not only reduces the weight of the shoe rack unit itself, it also saves materials for producing the shoe rack unit; people can watch the structural facade of the shoe through the opening, making it more convenient for to pick up or put down shoes; furthermore, the opening allows for good shoe ventilation.

The present invention further provides a shoe rack, comprising:

a shoe bracket and a plurality of shoe rack unit, said shoe rack unit is a shoe rack unit according to any one of the above-described shoe rack unit;

the shoe rack unit is stacked on top of the shoe bracket;

the shoe bracket comprises a base plate, both ends of the base plate extending upwardly to form a third plate and a fourth plate respectively;

the extension ends of the third plate and the fourth plate extend towards each other to form a third support plate and a fourth support plate respectively.

In this aspect, a shoe bracket matching the shoe rack unit is provided below the lowermost shoe rack unit, since the shoe bracket provides support and stabilization effect, it improves the stability of the shoe rack formed from the shoe rack units, reduces the load placed on the lowermost shoe rack unit, increases the service life of the lowermost shoe rack unit.

In this aspect, the design of the shoe bracket and the shoe rack unit is very simple and can be integrally formed, simple stacking can be used to assemble the shoe rack, one does not need to waste time finding cooperating parts before the assembly.

Furthermore, preferably a third magnetic member corresponding to said second magnetic member is provided on the upper surface of the third plate and on the upper surface of the fourth support plate.

In this aspect, the third magnetic member can improve compactness, stability and firm connection between the shoe rack unit and the shoe bracket.

Furthermore, preferably the lower surface of the base plate is provided with a counterweight.

In this aspect, the counterweight will increase the stability of the shoe bracket, thus ensuring the stability of the shoe rack.

Furthermore, preferably the lower surface of the base plate is provided with a foot pad for adjusting the height shoe bracket.

In this aspect, by adjusting the height of the foot pad, it is more convenient for people to use the shoe rack.

By providing a stackable shoe rack unit and a shoe rack made therefrom, the present invention can bring at least one of the following advantages:

1. In the present invention, the individual shoe rack units are interconnected through magnetic members. This not only allows tight interconnections between the individual shoe rack units, it also makes the shoe rack formed structurally stable, do not collapse or deform easily. The shoe rack unit can be used to form single-column-multiple-level shoe rack or multiple-column-multiple-level shoe rack. There is a wide range of ways for combining the individual shoe rack units that takes up little space. This type of stackable shoe rack is suitable for both shopping malls and home environment, has a wide range of potential applications, takes up minimum amount of space, is very practical and easy to use.

2. In the present invention, a shoe bracket matching the shoe rack unit is provided below the lowermost shoe rack unit, since the shoe bracket provides support and stabilization effect, it improves the stability of the shoe rack formed from the shoe rack units, reduces the load placed on the lowermost shoe rack unit, increases the service life of the lowermost shoe rack unit.

3. The present invention, the stackable shoe rack unit can be designed for a single pair of shoes or multiple pairs of shoes placed side-by-side, the size and style of the shoe rack unit can be selected based on the available space for a shoe rack, without having to consider making available enough space for the shoe rack, thus saves space and improves interior space utilization; in addition, identical or different shoe rack units can be assembled together placed in separate spaces according to user needs and local conditions; the shoe rack formed from the stackable shoe rack units can have diverse styles and is highly individualized.

4. In the present invention, the through hole provided on the shoe rack unit makes it more convenient for a user to move and assemble the shoe rack unit, reduces the weight of the shoe rack unit itself, makes it possible to view or select a pair of shoes via viewing through the through hole, and makes the design of the shoe rack unit is scientific and ergonomic.

5. In the present invention, the design of shoe rack unit and the support bracket unit is very simple and can be integrally formed, it can be just a simple superposition when assembled, one does not need to waste time finding cooperating parts before assembly to form the shoe rack.

### BRIEF DESCRIPTION OF THE DRAWINGS

Various embodiments of the invention are disclosed in the following detailed description and the accompanying drawings.

In a clear and understandable manner, in conjunction with description of the preferred embodiments with the accompanying drawings, the above-described characteristics, technical features, and advantages of the stackable shoe rack unit and shoe rack made therefrom in accordance with the present invention will be further described.

FIG. 1 is a schematic view of an embodiment of a stackable shoe rack unit in accordance with present invention;

FIG. 2 is a schematic bottom view of the structure of FIG. 1;

FIG. 3 is a schematic view of an embodiment of a shoe bracket in accordance with the present invention;

FIG. 4 It is a schematic front view of the structure of FIG. 3;

FIG. 5 is a schematic bottom view of the structure of FIG. 3;

FIG. 6 is a schematic front view of a first embodiment of a shoe rack in accordance with present invention;

FIG. 7 is a schematic front view of a second embodiment of a shoe rack in accordance with present invention;

FIG. 8 is a schematic front view of a third embodiment of a shoe rack in accordance with present invention.

Reference numerals: shoe rack unit 100, pallet 110, anti-slip belt 111, first plate 120, through hole 121, second plate 130, first support plate 140, second support plate 150, first magnetic member 160, second magnetic member 170, shoe bracket 200, base plate 210, third plate 220, fourth plate 230, third support panel 240, fourth support plate 250, third magnetic member 260, counterweight 270, foot pad 280.

### DETAILED DESCRIPTION

The invention can be implemented in numerous ways, including as a method; a process; an apparatus; a system; and/or a device. A detailed description of one or more embodiments of the invention is provided below along with accompanying figures that illustrate the principles of the invention. The invention is described in connection with such embodiments, but the invention is not limited to any embodiment. In the specification, the various implementations of the invention may be referred to as techniques or technical solutions. In general, the order of the steps of disclosed processes may be altered and one or more steps of disclosed processes may be omitted within the scope of the invention.

To further illustrate the technical solutions of the present invention and its implementations, the specific embodiments of the present invention will be described in reference to the accompanying figures. Apparently, the drawings described below are only some embodiments of the invention, those of ordinary skill in the art, without creative efforts, can derive other embodiments and drawings of the present invention.

For simplicity, the figures only schematically shows the part relevant to the present invention, they do not represent the actual structure of the present invention as a product. Furthermore, for simplicity and easy understanding, components having the same structure or function in some of the figures, only one of which is schematically illustrates, or only one of which is labeled. In this context, “a” represents both “only this one” can also mean the case of “more than one” of.

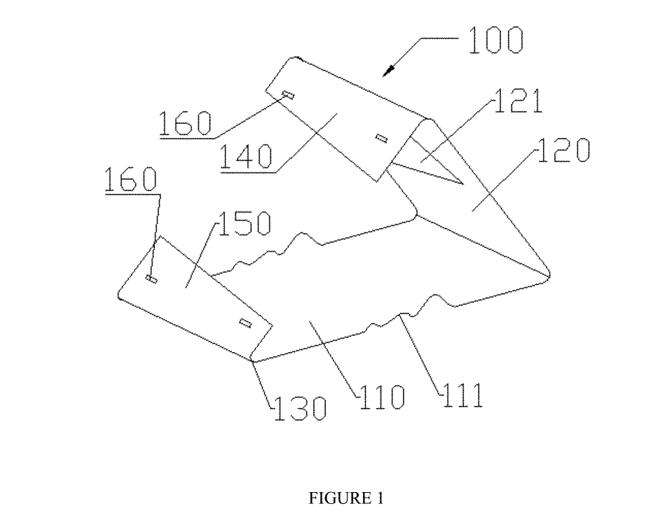

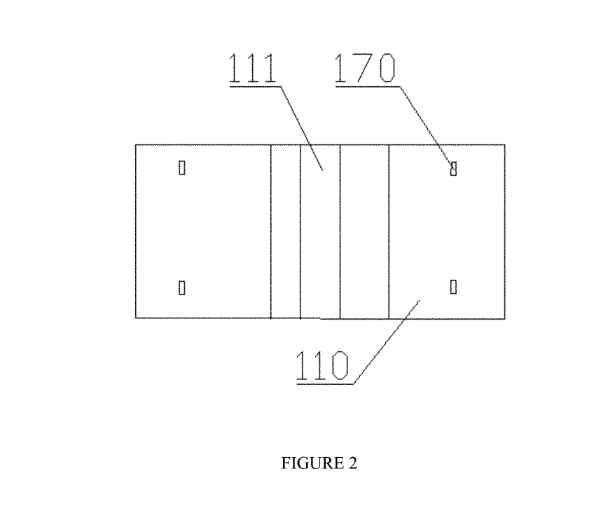

A first embodiment, as shown in FIGS. 1 and 2, a stackable shoe rack unit, comprising: a pallet for placing shoes (not shown in the drawing) 110, the pallet 110 extending upwardly at both ends for form a first plate 120 and second plate 130 respectively; the extension ends of the first plate 120 and the second plate 130 extend towards each other to form a first support plate 140 and a second support plate 150 respectively; the surfaces of the first support plate 140 and the second support plate 150 are each provided with a first magnetic member 160; the lower surface of the pallet 110 is provided with a second magnetic member 170 matching the first magnetic member 160.

A second embodiment, as shown in FIGS. 1 and 2, described on the basis of the first embodiment, the upper surface of the pallet 110 is provided with an anti-slip belt 111, the anti-slip belt 111 may be part of the pallet 110 structure itself, for example the anti-slip belt 110 is formed by a wavy uneven upper surface of pallet 110; the anti-slip belt 111 may be formed by a structure added onto the pallet 110, for example the anti-slip belt 111 may be formed by a strip of adhesive with uneven or irregularly shaped lumps added to the pallet 110. The direction and position of the pallet 110 can be set depending on the application, the non-slip belt 111 is preferably disposed both in the top and bottom direction of the pallet 110, but also on the right and left sides of the pallet 110, in this way it can prevent the shoes from slipping in the vertical direction of the pallet 110 and the horizontal direction of the pallet 110, overall improves the stability of the shoes placed on the shoe rack unit 100. The vertical height of the first plate 120 is greater than the vertical height of the second plate 130, in addition the first plate 120 is provided with a through hole 121; the first support plate and the second support plate 150 are placed on the same inclined plane, moreover an opening (not labeled) is provided between the extension ends of the first support plate 140 and the second support plate 150. By providing the through hole 121 and the opening, the present invention reduces the weight of the shoe rack unit 110, saves materials for making the shoe rack unit 110, and elevates the vantage point for viewing the shoes. The opening also improves the air ventilation of the shoe rack unit 100, making it convenient to pick up and put down shoes.

A third embodiment, shown in FIGS. 1 and 2, described based on the first embodiment and the second embodiment, the longitudinal cross-section of the shoe rack unit 110 is triangular, that is the pallet 110, the first plate 120, the first support plate 140 and the second support plate 150 form a triangle. The triangular structure is the most stable structure, therefore triangular shaped shoe rack unit 100 has excellent stability, the shoe rack formed by a plurality of triangular shaped shoe rack unit also has excellent stability. Preferably the triangle is an isosceles triangle, and the first plate 120 forms the base of the isosceles triangle; In a specific embodiment, when the apex angle of the isosceles triangle is preferably 40°, the shoe rack unit 100 and the angle formed by the tip of sneaker is compatible, when sneakers are placed on the shoe rack unit 100, the shoe rack unit 100 utilization is maximized.

It should be noted that the shoe rack unit not only can be an integral unit by itself, it can also be combined with various other fitting components, one skilled in the art can design and manufacture the shoe rack unit of the present invention according to individual needs. The cross-sectional shape of the shoe rack unit can be regular or irregular polygon, it can also be designed based on the shape, size, and configuration of the shoes to be stored, this increases the usability and individuality of the shoe rack. In actual design and production of the shoe rack unit, the size and structure of the shoe rack unit can be designed based how many pairs of shoes are needed to be stored; of course, it can also be designed and manufactured based on the space available for a shoe rack, we will not describe all the possibilities here.

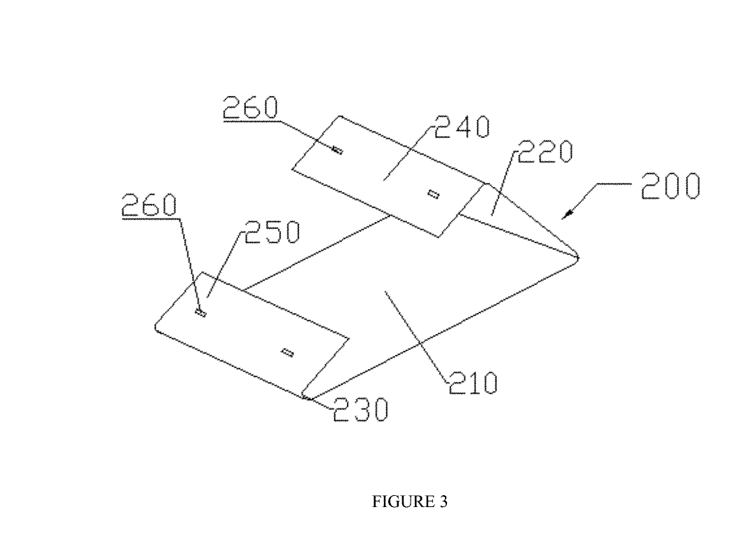

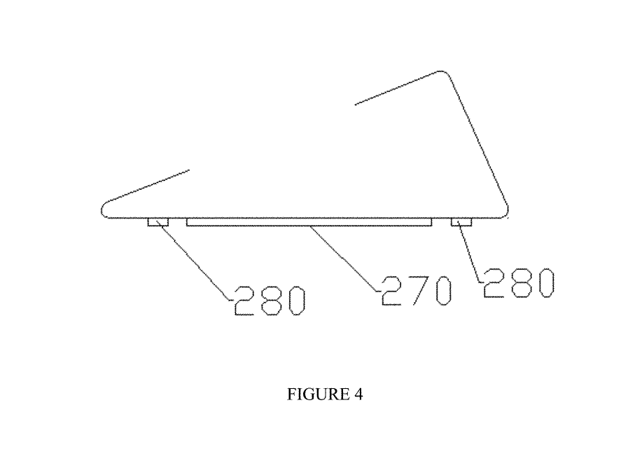

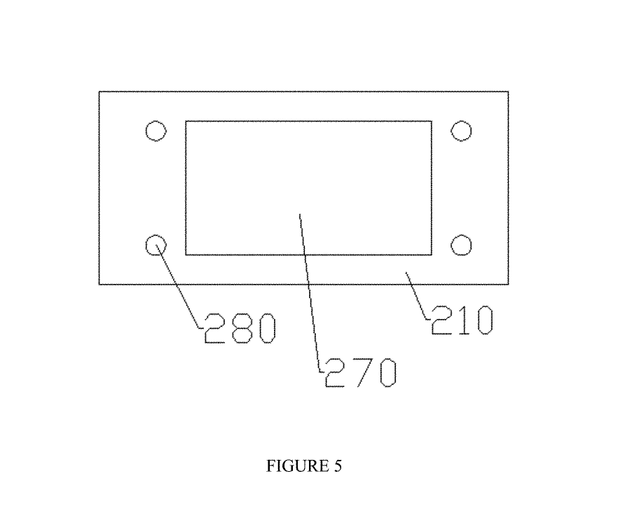

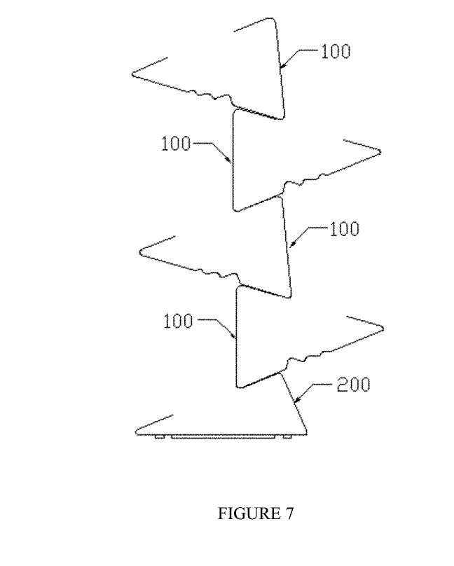

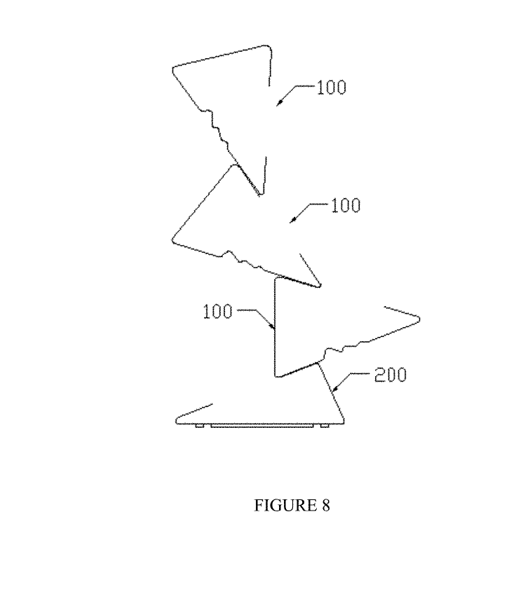

A fourth embodiment, as shown in FIG. 3-8, is a shoe rack that comprises: a shoe bracket 200 and a plurality of shoe rack unit 100, the shoe rack unit 100 is stacked on top of the shoe bracket 200; shoe bracket 200 includes a base plate 210, both ends of the base plate 210 extending upwardly to form a third plate 220 and a fourth plate 230 respectively; the extension ends of the third plate 220 and the fourth plate 230 extending towards each other to form a third support plate 240 and a fourth support plate 250 respectively.

It is noteworthy that, when the shoe bracket is not made of a magnetic material, the stability of the shoe is achieved through frictional force and supportive force; when the shoe bracket is made of iron or other magnetic material, the magnetic force between the shoe bracket and the shoe rack unit further increases the stability of the shoe rack.

A fifth embodiment, as shown in FIGS. 3-8, is described based on the fourth embodiment, the surfaces of the third support plate 240 and the fourth support plate 250 of the shoe bracket 200 are all provided with a third magnetic member 260 corresponding to the second magnetic member 170. In this case, it does not matter what material the shoe rack unit 100 is made of, the magnetic force between the shoe bracket 200 and the shoe rack unit 100 increases the stability of the shoe rack. More preferably, the lower surface of the base plate 210 is provided with a counterweight 270, further improving the stability of the shoe rack. The lower surface of the base plate 210 is provided with a foot pad for adjusting the height of the shoe bracket 200, in this way one can adjust the height of the entire shoe rack based on practical needs.

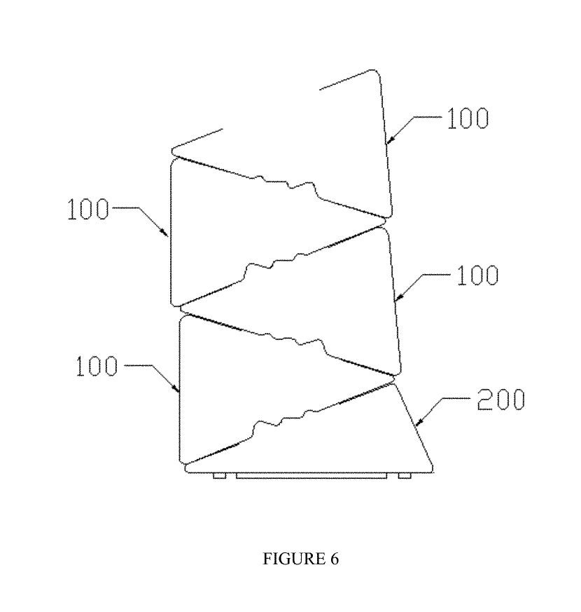

A sixth embodiment, as shown in FIG. 6-8, described based on the fourth and the fifth embodiments, there are many possible combinations for the shoe rack unit 100. The shoe rack unit 100 can be stacked in a head-to-tail (staggered) fashion (that is the first magnetic member 160 and the second magnetic member 170 are completely connected and touching each other), the stacked shoe rack unit 100 is then stacked on top of the shoe bracket 200. The shoe rack unit 100 can also be stacked together in a tail-to-tail (parallel) fashion, the stacked shoe rack unit is then stacked on top of the shoe bracket 200. Of course, there are a variety possible ways to stack the shoe rack unit 100 and the shoe bracket 200, we will not describe them all here.

It should be noted that the above described embodiments can be freely combined as needed. It should also be noted that the above are only preferred embodiments of the invention, those of ordinary skilled in the art, without departing from the principles of the present invention, can make various improvements and modifications, such modifications and modifications should be within the scope of the present invention.

The subject matter of the present disclosure includes all novel and nonobvious combinations and sub-combinations of the various processes, systems, devices, composition of matters, and configurations, and other features, functions, acts and/or properties disclosed herein, as well as any and all equivalents thereof.

The disclosed embodiments and various details are merely illustrative and are not to be construed as limiting and the invention can be implemented in various alternative ways. Further, the scope of the invention is limited only by the claims and the invention encompasses numerous alternatives, modifications and equivalents.

What is claimed is:

1. A stackable shoe rack unit, comprising:
a pallet for placing shoes, a first end and a second end of the pallet extending upwardly to form a first plate and a second plate respectively; the first plate and the second plate each comprises an extension end, and extend towards each other at their respectively extension ends to form a first support plate and a second support plate respectively;
a first magnetic member is provided on upper surfaces of the first support plate and the second support plate;
a second magnetic member adapted to the first magnetic member is provided on bottom surface of the pallet.

2. The stackable shoe rack unit according to claim 1, wherein:
said upper surface of the pallet is provided with anti-slip belt.

3. The stackable shoe rack unit according to claim 1, wherein:
vertical height of the first plate is greater than vertical height of the second plate, the first plate is provided with a through hole.

4. The stackable shoe rack unit according to claim 3, wherein:
the first support plate and the second support plate are on the same inclined plane.

5. The stackable shoe rack unit according to claim 1, wherein:
the first support plate and the second support plate are on the same inclined plane.

6. The stackable shoe rack unit of claim 1, wherein:
said pallet, said first plate, said first support plate and the second support plate form a three-sided member with rounded corners.

7. The stackable shoe rack unit according to claim 6, wherein:
said three-sided member has a cross-sectional outline approximating an isosceles triangle.

8. The stackable shoe rack unit according to claim 7, wherein:
an angle of the three-sided member is 40°.

9. The stackable shoe rack unit according to claim 6, wherein:
an angle of the three-sided member is 40°.

10. The stackable shoe rack unit according to claim 1, wherein:
an opening is provided between the extension ends of the first support plate and the second support plate.

11. The stackable shoe rack unit according to 1, wherein:
said upper surface of the pallet is provided with anti-slip belt.

12. A shoe rack, comprising:
a shoe bracket; and a plurality of shoe rack units,
wherein said shoe rack unit comprises:
a pallet for placing shoes, a first end and a second end of the pallet extending upwardly to form a first plate and a second plate respectively; the first plate and the second plate each comprises an extension end, the extension end of the first plate and the extension end of the second plate extend towards each other to form a first support plate and a second support plate respectively;
a first magnetic member is provided on upper surfaces of the first support plate and the second support plate;
a second magnetic member adapted to the first magnetic member is provided on bottom surface of the pallet;
wherein vertical height of the first plate is greater than vertical height of the second plate, the first plate is provided with a through hole;
the first support plate and the second support plate are on the same inclined plane:
said pallet, said first plate, said first support plate and the second support plate form a three-sided member with rounded corners;
wherein said shoe rack unit is stacked on top of the shoe bracket;
wherein said shoe bracket comprises:
a base plate, a first end and a second of the base plate extending upwardly to form a third plate and a fourth plate respectively;
the third plate and the fourth plate each comprises an extension end and said extension ends of the third plate and extension end of the fourth plate extend towards each other to form a third support plate and a fourth support plate respectively.

13. The shoe rack of claim 12, wherein:
the upper surfaces of the third support plate and said fourth plate are each provided with a third magnetic member adapted to said second magnetic member.

14. The shoe rack of claim 12, wherein:
the lower surface of the base plate is provided with a counterweight.

15. The shoe rack according to any one of claim 12, wherein:
the lower surface of the base plate is provided with a foot pad for adjusting the height of the shoe bracket.

16. The shoe rack according to claim 12, wherein:
the upper surface of the third support plate and said fourth plate are each provided with a third magnetic member adapted to said magnetic member.

17. A shoe rack, comprising:
a shoe bracket and a plurality of stackable shoe rack units;
wherein:
said shoe rack unit is stacked on top of the shoe bracket;
said shoe bracket includes a base plate, a first end and a second end of the base plate extending upwardly to form a first bracket plate and a second bracket plate respectively;
the first bracket plate and the second bracket plate each comprises an extension end and said extension ends of the first bracket plate and the second bracket plate extend towards each other to form a first support plate and a second support plate respectively.

18. The shoe rack of claim 17, wherein:
an upper surface of the first bracket support plate and said second bracket plate are each provided with a magnetic member.

19. The shoe rack of claim 17, wherein:
the lower surface of the base plate is provided with a counterweight.

20. The shoe rack of claim 17, wherein:
the lower surface of the base plate is provided with a foot pad for adjusting the height of the shoe bracket.
